(19) United States
(12) Patent Application Publication
(10) Pub. No.: US 2006/0024994 A1
(43) Pub. Date: Feb. 2, 2006

(54) Clamp device for long component

(75) Inventor: Hiroyuki Kato, Utsunomiya-shi (JP)

Correspondence Address: MILES & STOCKBRIDGE PC, 1751 PINNACLE DRIVE, SUITE 500, MCLEAN, VA, 22102-3833, US

(73) Assignee: Newfrey LLC

(21) Appl. No.: 11/185,714

(22) Filed: Jul. 21, 2005

(30) Foreign Application Priority Data
Jul. 30, 2004 (JP) 2004-223364

(51) Int. Cl. H01R 13/648

(52) U.S. Cl. 439/92

(57) ABSTRACT

A clamp device for a long component is engaged to a conductive stud attached to a conductive support, in order to conductively mount the long component to the support. The clamp device comprises a clamp made of an electrically conductive hard plastic material having a base for holding the long component, a cover made of a hard plastic material connected to the clamp so as to enclose the long component on the base, and a stud fastener made of a hard plastic material for mounting both the clamp and the cover on the stud and electrically connecting the long member held inside the clamp to the stud. Conductive plates on the clamp contact the stud in the stud fastener.

### CROSS-REFERENCE TO RELATED APPLICATION

This application claims the benefit of Japanese Application 2004-223364 filed Jul. 30, 2004, incorporated herein by reference.

### BACKGROUND OF THE INVENTION

Plastic clamp devices for mounting long components such as fuel or brake lines to car bodies are well known. The friction caused by the passage of fuel or brake fluid through these lines causes them to pick up an electrical charge. The fuel reacts to the charged line, causing the flow of fuel through the line to go less smoothly. Sparks also occur on the outer surface of the lines, causing pin holes to develop in the coating on the surface of the lines.

A line mounting unit is disclosed in Japanese Unexamined Patent Application Publication [Kokai] No. 2000-266240 (Patent Document 1) that solves the problem of charged fuel lines by supporting the lines in a conductive line holder made of carbon black dispersed in polypropylene. This line holder is screwed into a car body using a steel bracket. A line mounting device is also disclosed in U.S. Pat. No. 6,450,459 (Patent Document 2). This line mounting device is made of hard plastic and has a base mounted on a stud and a line clip for holding lines. Here, the lines are connected to the line mounting device, the line mounting device is mounted on a stud, and an electrical connection is established between the lines and a body panel using an electrical connection component made of a conductive material.

Because the line mounting unit in Patent Document 1 consists of a conductive material such as carbon black mixed into a flexible material such as polypropylene to make the line holder conductive, the unit does not have enough line holding strength. Also, because a bracket has to be screwed into a car body, the mounting process is complicated and time-consuming. Because the line mounting device in Patent Document 2 holds the lines using a hard plastic pipe holder, it has good line holding strength. Also, because the device is mounted on a stud attached to a car body, a screwing in operation is not required. As a result, less time is required for the mounting operation. However, because the electrical connection component is formed separately from the line holding device, the attachment to the line holding device leaves room for improvement.

Japanese Unexamined Utility Model Application Publication 4-082414 (Patent Document 3) discloses a line holding device in which a stud engaging portion consists of an inner tube and outer tube to improve the stud engaging strength. However, Patent Document 3 makes no mention at all of discharging the charge stored in the lines to a car body. Japanese Unexamined Utility Model Application Publication 6-047795 (Patent Document 4) discloses a line holding device in which the mounting position can be changed lengthwise and perpendicularly with respect to the lines when the line holding device is mounted on a stud. However, Patent Document 4 makes no mention at all of discharging charge stored in the lines to a car body.

### BRIEF DESCRIPTION OF THE INVENTION

An object of the present invention is to provide a clamp device with a simple fastening operation, for discharging an electrical charge from a charged long component to a support, while maintaining sufficient holding strength when a long component such as a line is mounted to a support such as a car body.

In one non-limiting embodiment, the present invention provides a clamp device for engaging a stud attached to a support in order to mount a long component to the support, wherein the clamp device comprises a one-piece clamp made of an electrically conductive hard plastic material having a base for holding the long component, a one-piece cover made of a hard plastic material connected to the clamp so as to enclose the long component on the base, and a one-piece stud fastener made of a hard plastic material for mounting both the clamp and the cover on the stud and electrically connecting the long member held inside the clamp to the stud.

As described above, a long component is held by a conductive clamp and enclosed by a cover to hold it more securely. The clamp is mounted on a stud using a stud fastener, and the long component held by the clamp is electrically connected to the stud via the clamp in a reliable way. A simple fastening operation is performed for discharging an electrical charge from a charged long component to a support while maintaining sufficient holding strength when a long component such as a line is mounted to a support such as a car body.

The preferred clamp in the present invention is made of a conductive plastic comprising a conductive material such as carbon black mixed into a rigid yet flexible plastic material such as polyacetal. This conductive plastic material is hard and does not stretch much. Because part of the clamp device is conductive, a separate electrical connection component does not have to be provided.

In this clamp device, a base of the clamp has a stud receiver with a hole to receive a stud. Conductive plates extend inside the stud receiver to establish electrical contact with the side of the stud when the stud receiver receives a stud. As a result, the electrical connection of the clamp to the stud is more reliable, and thus discharging the electrical charge stored by the long component to a conductive support such as a car body is also reliable.

In this clamp device, the cover has a latch connected and secured to the clamp, a covering portion connected by a hinge to the latch so as to be opened to arrange the long component on the base and closed to enclose and hold the long component on the base, and a fastener connector having a hole into which the stud fastener is inserted, extending parallel to the stud receiver. The covering portion encloses the long component on the clamp by simply turning the covering portion around the hinge.

In this clamp device, the stud fastener comprises a tube for receiving the stud and having a head on one end of the tube, Elastic pawls are formed on the inside of the tube to engage threads or circumferential grooves on the side of the stud. The tube is inserted into the fastener connector of the cover, causing the elastic pawls to engage the threads or circumferential grooves on the side of the stud and causing the clamp and the cover to be mounted on the stud. The tube causes the conductive plates to apply pressure to the side of the stud. Because the clamp and the cover are connected to the stud using a stud fastener, the clamp device mounting operation on the stud is simple.

In this clamp device, the fastener connector of the cover and the end of the tube opposite to the head have engagement means that engage before the stud fastener receives the stud. Because the stud fastener can be maintained in this state before being pushed onto the stud, the clamp device can be sent to an assembly site for long components such as fuel lines or an assembly site for supports such as car bodies, for example, before being pushed onto the stud.

### BRIEF DESCRIPTION OF THE DRAWINGS

The invention will be further described in conjunction with the accompanying drawings, which illustrate a preferred (best mode) embodiment, and wherein:

FIG. 1 is a plan view of a clamp device in an example of the present invention;

FIG. 2 is a front view of the clamp device in FIG. 1;

FIG. 3 is a cross-sectional end view from line 3-3 in FIG. 1;

FIG. 4 is a plan view of the clamp in the clamp device in FIG. 1;

FIG. 5 is a front view of the clamp in FIG. 4;

FIG. 6 is a bottom view of the clamp in FIG. 4;

FIG. 7 is a left-side view of the clamp in FIG. 4;

FIG. 8 is a cross-sectional end view from line 8-8 in FIG. 4;

FIG. 9 is a plan view of the cover for the clamp device in FIG. 1;

FIG. 10 is a front view of the cover in FIG. 9;

FIG. 11 is a bottom view of the cover in FIG. 9;

FIG. 12 is a left-side view of the cover in FIG. 9;

FIG. 13 is a cross-sectional end view from line 11-11 in FIG. 9;

FIG. 14 is a plan view of the stud fastener for the clamp device in FIG. 1;

FIG. 15 is a front view of the stud fastener in FIG. 14;

FIG. 16 is a bottom view of the stud fastener in FIG. 14;

FIG. 17 is a left-side view of the stud fastener in FIG. 14;

FIG. 18 is a cross-sectional end view from line 18-18 in FIG. 14;

FIG. 19 is a cross-sectional end view from line 19-19 in FIG. 15;

FIG. 20 is a front view of the clamp device holding a line before final mounting on a stud;

FIG. 21 is a cross-sectional end view of the clamp device in FIG. 20;

FIG. 22 is a front view of the clamp device holding a line after final mounting on a stud; and

FIG. 23 is a cross-sectional end view of the clamp device in FIG. 22.

### DETAILED DESCRIPTION OF THE INVENTION

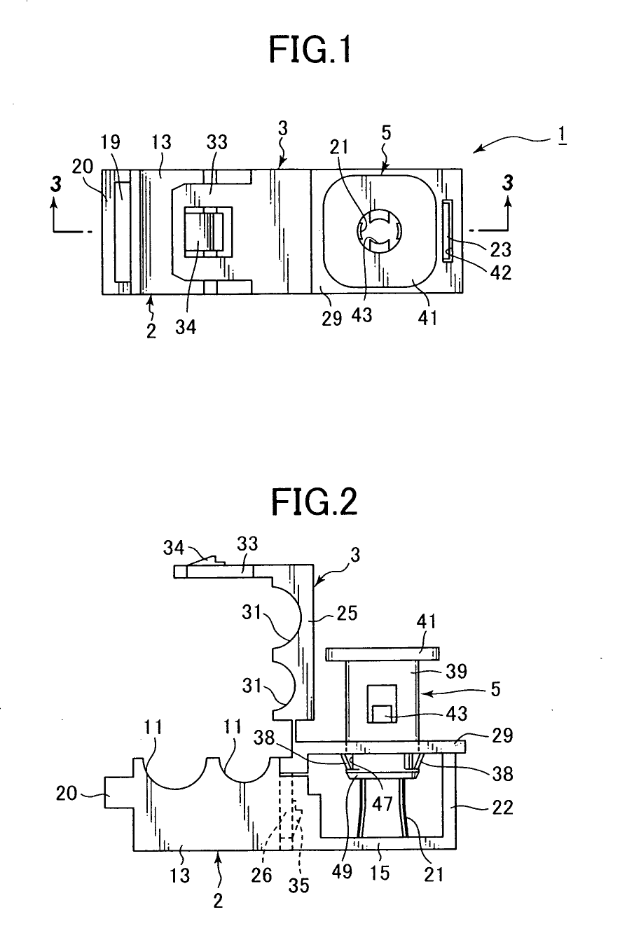

The following is an explanation of an example of the present invention with reference to the drawings. As shown in FIG. 1 through FIG. 3, the clamp device 1 comprises a one-piece clamp 2 made of a conductive hard plastic for holding one or more long components such as fuel lines, a one-piece cover 3 made of a hard plastic connected to the clamp 2 so as to enclose long components in the clamp 2, and a one-piece stud fastener 5 made of a hard plastic for mounting the clamp 2 and the cover 3 on a conductive stud such as a rod-shaped metal stud bolt attached to a conductive support such as a car body. The cover 3 and the stud fastener 5 have electrically insulating properties, and are both flexible as well as durable. They are made of a hard plastic material such as an engineering plastic. When the clamp device 1 is mounted on a conductive stud, the clamp 2 is connected thereto electrically. As a result, a long component such as a line held in the clamp 2 is connected electrically to a conductive support such as a car body via the clamp 2 and the stud, and any electrical charge stored by the long component is discharged to the support. The clamp 2 makes electrical contact with a support such as a car body. However, if the car body is painted to prevent rust, the electrically insulating properties of the paint will not allow for a direct electrical connection of the clamp 2 to the support.

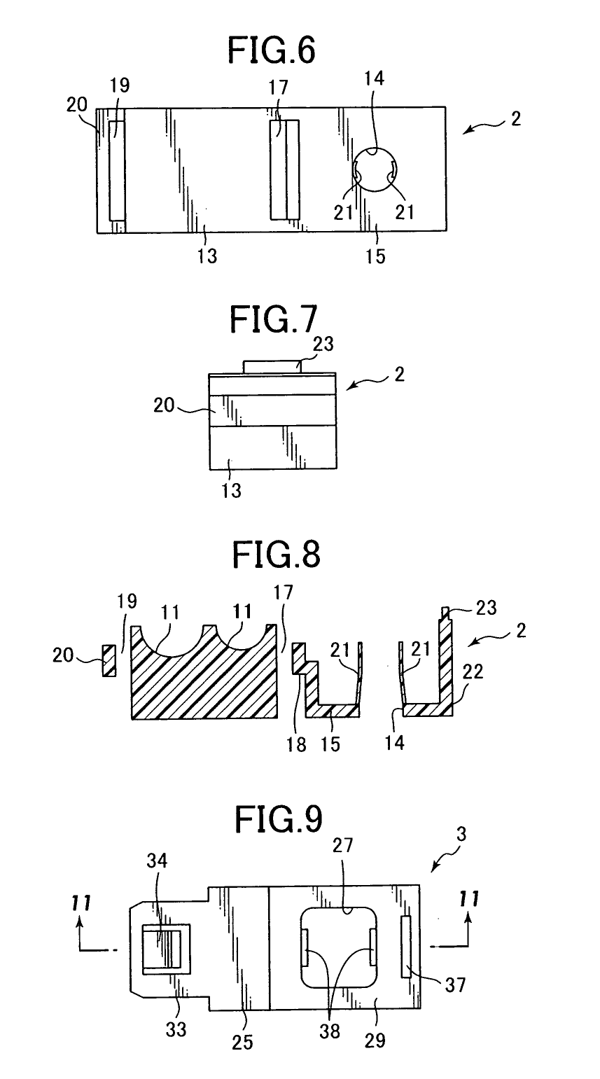

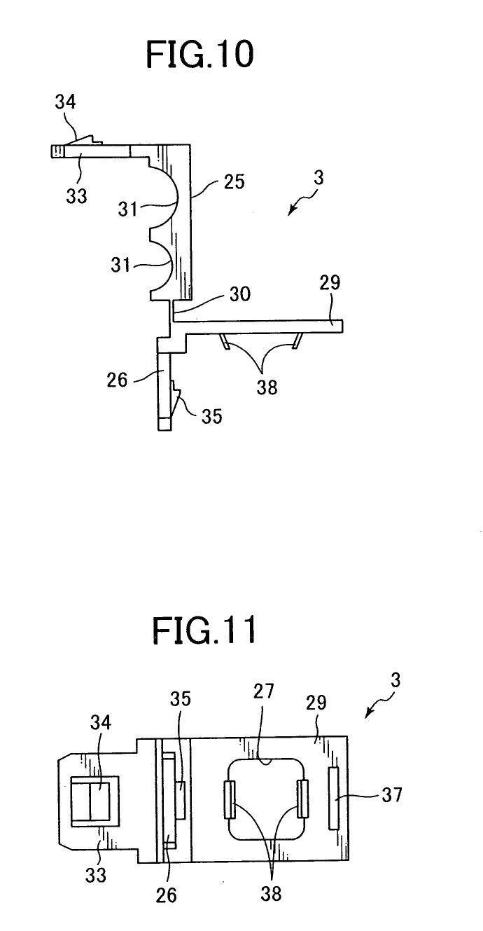

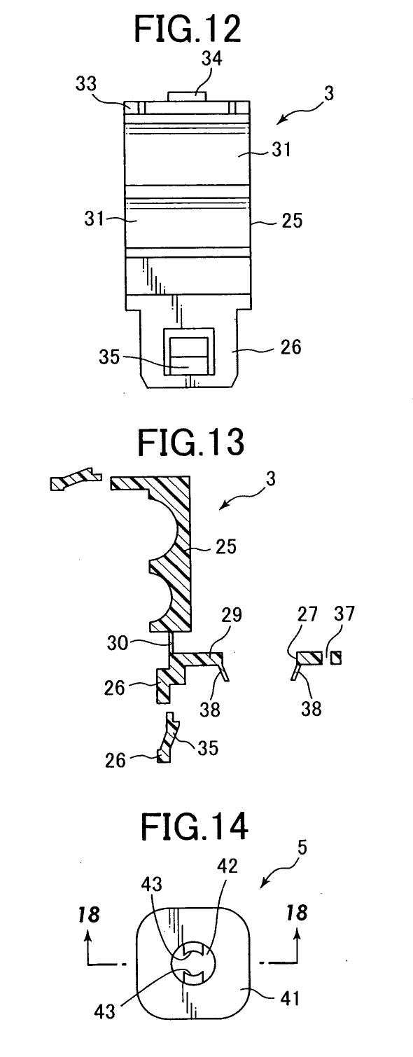

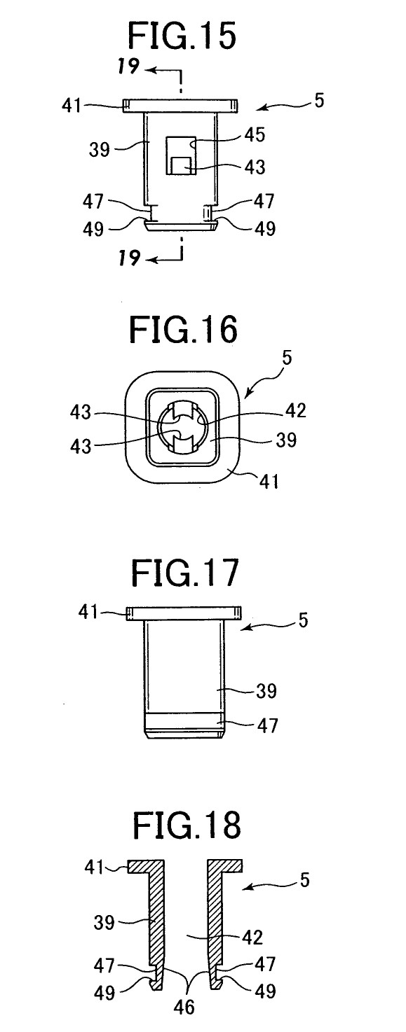

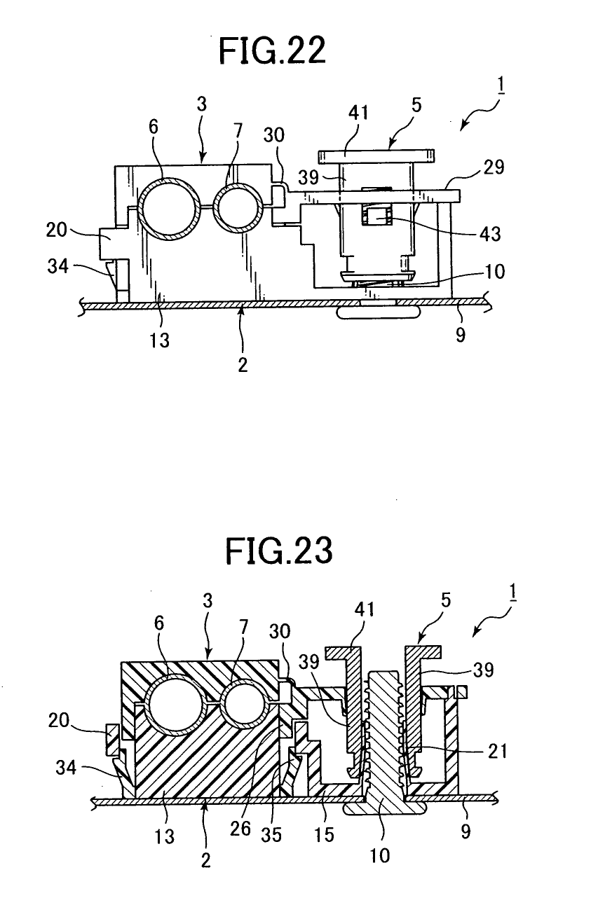

The clamp 2 is shown in greater detail in FIG. 4 through FIG. 8. The cover 3 is shown in greater detail in FIG. 9 through FIG. 13. The stud fastener 5 is shown in greater detail in FIG. 14 through FIG. 19. FIG. 20 and FIG. 21 show fuel lines 6, 7 serving as long components held in the clamp device 1, which is to be mounted on a rod-shaped conductive stud 10 such as a stud bolt or circumferentially grooved stud attached to a car body 9 serving as a support. FIG. 22 and FIG. 23 show the fuel lines 6, 7 mounted on the car body 9 by the clamp device 1 via the stud fastener 5 and the stud 10.

The following is an explanation of the clamp 2 in greater detail with reference to FIG. 4 through FIG. 8. The clamp 2 is preferably a one-piece integral molded component made of a hard conductive plastic. The hard conductive plastic can be a conductive material such as carbon black mixed into a hard yet flexible plastic material such as polyacetal. This conductive plastic material does not stretch much. The clamp 2 comprises base 13 with recesses 11 to hold long components, and a stud receiver 15 extending from the base 13 with a hole 14 in the center to receive a stud. A latch hole 17 is formed in the side surface of the base 13 adjacent to the stud receiver 15 to connect the cover 3 to the base 13 so as to enclose long components in the recesses 11. A shoulder 18 is formed in the latch hole 17 as shown in FIG. 8. An arm 20 with a second latch hole 19 is formed on the opposite side surface of the base 13 to keep the cover 3 closed.

A pair of conductive plates 21 rise from an edge of the stud receiving hole 14 in the stud receiver 15. These conductive plates 21 are pressed onto the side of the stud when the stud fastener 5 is pushed onto a stud. Pressing of the conductive plates 21 makes the electrical connection of the clamp 2 to the stud more reliable, and thus makes discharging the electrical charge stored in the long components to a car body more reliable. The length and shape of the conductive plates 21 are selected to make contact with the stud more reliable and to keep the stud fastener 5 per se from pushing on the stud. The number of conductive plates 21 is also selected to make the electrical connection to the stud more reliable and to keep the stud fastener 5 per se from pushing on the stud.

A sidewall 22 of the stud receiver 15 remote from base 13 of the clamp 2 supports part of the cover 3 and makes the connection of the cover to the clamp 2 more reliable. The height of the side wall 22 is based on the height of the base 13 of the clamp 2. A protrusion 23 at the apex of the side wall 22 positions a fastener connector 29 (explained below) on the cover 3.

The following is a more detailed explanation of the cover 3 with reference to FIG. 9 through FIG. 13. The cover 3 comprises a covering portion 25 for enclosing the long components in the recesses 11 of the clamp 2, a latch 26 for connecting and securing the cover to the base 13 of the clamp 2, and a fastener connector 29 extending horizontally from the latch 26 parallel to the bottom of the stud receiver 15, with a hole 27 formed in the center to receive a stud and the stud fastener 5. The latch 26 and the fastener connector 29 are integral so as to form a rigid body, and the covering portion 25 is integral with the latch 26 and the fastener connector 29 via a thin hinge 30 so as to be able to turn with respect to the latch 26 and the fastener connector 29. The cover can be opened to arrange long components in the recesses 11 in the base 13 and can be closed to enclose the long components in the recesses 11 and secure them to the base. Because the long components are enclosed and secured inside the clamp 2 using a cover 3, there is no need to provide elastic plates in a clamp 2 in order to apply elastic pressure to sides of long components.

Recesses 31 are formed in the covering portion 25 at positions opposite to the recesses 11 in the base 13 in order to receive and enclose the long components in the recesses 11. A second latch 33 is formed at the end of the covering portion 25 opposite to the hinge 30 in order to keep the covering portion 25 closed, and a latch pawl 34 is formed in the center of the latch 33. Pawl 34 is inserted into the second latch hole 19 on the base to engage the arm 20 and keep the covering portion 25 closed. The latch pawl 34 is elastic and can be disengaged by applying pressure using a thin rod-shaped tool such as the head of a screwdriver.

The latch 26 connects and secures the cover 3 to the clamp 2. The latch 26 is a rigid plate-shaped component that extends downward along the side of the clamp 2. An elastic latch pawl 35 is formed at the tip of the latch 26 to engage the shoulder 18 (FIG. 8) in the latch hole 17. When the pawl 35 engages the shoulder 18, the cover 3 is connected securely to the clamp 2 due to the rigidity of the latch 26. The pawl 35 is elastic and can be disengaged by applying pressure using a thin rod-shaped tool such as the head of a screwdriver.

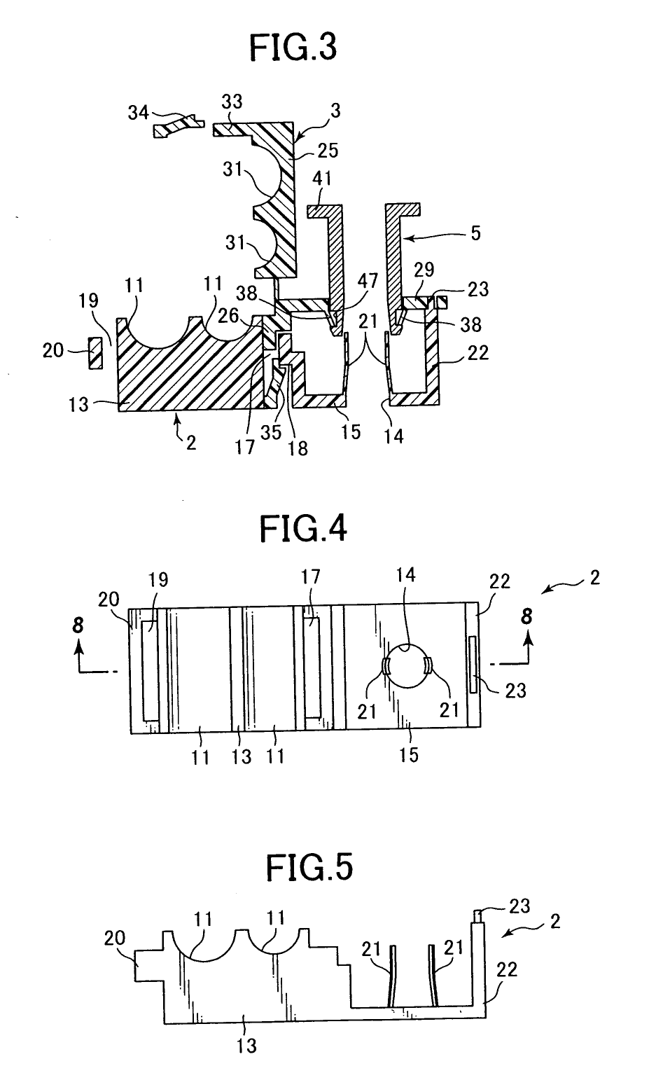

The fastener connector 29 is a plate-shaped component that extends perpendicularly with respect to the latch 26. The hole 27 formed in the center of the plate-shaped fastener connector 29 has a polygonal (e.g., nearly square) cross-section in order to conform to the outer peripheral shape of the stud fastener 5. A receiving hole 37 is formed at an end of the fastener connector 29 to receive the protrusion 23 on the side wall 22 of the clamp 2 and position the fastener connector 29 parallel to the bottom of the stud receiver 15. A pair of small elastic plates 38 converge downward from edges of the hole 27. The plates 38 function to hold the clamp device in the state shown in FIG. 3 before the stud fastener 5 is pushed onto a stud, and to keep the stud fastener 5 from coming out of the fastener connector 29.

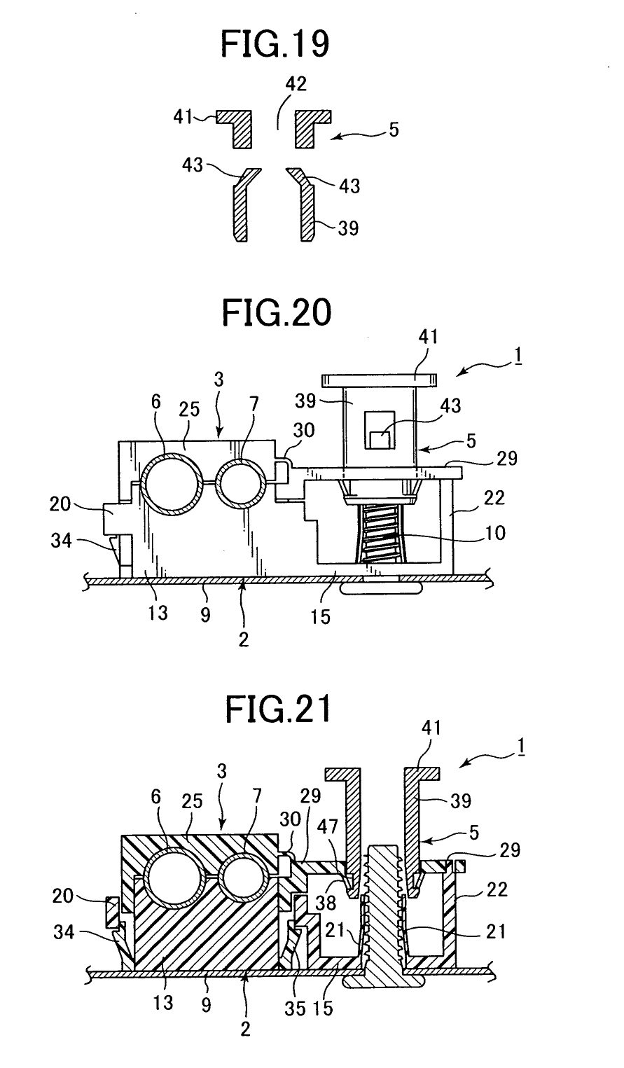

The following is a detailed explanation of the stud fastener 5 with reference to FIG. 14 through FIG. 19. The stud fastener 5 is an integral molded product comprising a tube 39 for receiving the stud, with a head 41 at an end of the tube 39 that is wider than the tube 39 and is shaped so as to allow it to be pressed by a finger. The tube 39 has a cylindrical bore 42 for receiving a stud, and has a polygonal cross-section that improves the rigidity of the tube 39 and fits the hole 27 in the fastener connector 29 on the cover 3 when the tube 39 is inserted into the hole 27. A pair of elastic pawls 43 are formed on the inside of the tube 39 approximately in the middle lengthwise (see FIG. 19) in order to engage threads or circumferential grooves on the side of a stud.

A window 45 is formed in the portion with the elastic pawls 43 in FIG. 15, but that is not necessary. The diameter of the hole 42 in the tube 39 is slightly greater than the outer diameter of a stud to maintain retention force on the stud via plates 21 after it has been pushed into the stud fastener 5.

As shown in FIG. 18, the lower portion of the tube 39 is formed as a tapered section 46 widening toward the bottom of the tube. The tapered section 46 is formed so as to receive the conductive plates 21 in the stud receiver 15 on the clamp 2 and apply pressure to the stud. A pair of peripheral grooves 47 are formed in the outer surface at the bottom end of the tube 39 to engage the plates 38 in the fastener connector 29 on the cover 3. The grooves 47 form shoulders 49 to engage the plates 38 on the fastener connector 29, and function to maintain the state shown in FIG. 3 before the stud fastener 5 is inserted onto a stud.

The following is an explanation with reference to FIG. 1 through FIG. 3 of the clamp device 1 once the conductive clamp 2, cover 3 and stud fastener 5 have been assembled. In order to secure the cover 3 to the clamp 2, the latch 26 on the cover 3 is inserted into the hole 17 in the base 13 of the clamp 2, and the pawl 35 is engaged with the shoulder 18 in the hole 17. The protrusion 23 on the stud receiver 15 is inserted in the hole 42 in the fastener connector 29 on the cover 3, and the fastener connector 29 is positioned parallel to the bottom of the stud receiver 15 and secured. The bottom end of the tube 39 in the stud fastener 5 is inserted into the hole 27 in the fastener connector 29 on the cover 3, and the grooves 47 in the tube 39 are engaged with the plates 38 on the edges of the hole 27 in the fastener connector 29. In this way, the stud fastener 5 is maintained as shown in FIG. 3 before insertion onto a stud, and is kept from coming out of the hole 27. This is how the clamp device 1 is maintained before insertion of a stud. The clamp device 1 can be transported in this state to a site where long components such as fuel lines are assembled or a site where supports such as car bodies are assembled.

Long components can be enclosed in a clamp device 1 as shown in FIG. 1 through FIG. 3 by turning the covering portion 25 of the cover 3 on the hinge 30 over the long components inside the recesses 11 in the base 13 of the clamp 2. When the stud fastener 5 is pushed onto a stud, the tapered section 46 at the end of the tube 39 leads the conductive plates 21 inside; the elastic pawls 43 engage the threads or circumferentially grooved side of the stud; and the stud fastener 5 is thus mounted on the stud. Because the clamp 2 and the cover 3 are mounted on the stud simply by pushing on the stud fastener 5, the clamp device 1 functions as a one-touch (or one-push) fastening device, and the operation required to mount the clamp device 1 on the stud is extremely simple.

The following is an explanation with reference to FIG. 20 through FIG. 23 of the operation used to mount long components such as fuel lines 6, 7 to a support such as a car body 9 using a clamp device 1. In FIG. 20 and FIG. 21, the fuel lines 6, 7 are arranged inside the recesses in the base 13 of the clamp 2; the covering portion 25 on the cover 3 is turned around the hinge 30 to enclose the fuel lines 6, 7, the pawl 34 engages the arm 20: and the fuel lines 6, 7 are held by the clamp 2. A stud 10 is then received in the receiving hole in the stud receiver 15 of the clamp 2, and is inserted partially into the tube 39 of the stud fastener 5 to position the clamp device 1 on the car body 9.

In FIG. 22 and FIG. 23, an operator has pushed the head 41 of the stud fastener 5 towards the stud 10 using a finger or a component such as a tool. This action causes the elastic pawls 43 in the tube 39 to engage threads or circumferential grooves in the stud, so that the stud fastener 5 is connected to the stud 10. The conductive plates 21 on the inside of the tube 39 press onto and establish contact with the stud 10. Attaching the tube 39 to the stud 10 attaches the clamp device 1 to a car body 9.

Because the lines 6, 7 are being held by the clamp 2, the lines 6, 7, too, are attached to the car body 9. Because the clamp 2 is electrically conductive, any electrical charge stored in the lines 6, 7 is discharged to the stud 10 via the base 13 and the stud receiver 15 of the clamp 2. Because conductive plates 21 are formed in the stud receiver 15 and the tube 39 causes them to come into contact with the side of the stud 10, the electrical connection of the clamp 2 to the stud 10 is more reliable, and thus the discharging of the electrical charge stored by the lines 6, 7 is also more reliable. Because the clamp 2 and the cover 3 are mounted on the stud 10 simply by pushing on the stud fastener 5, the operation required to mount the clamp device 1 on the stud is extremely simple. Because a conductive plastic clamp is mounted on a stud using a stud fastener, the clamp device mounting operation is simple and occurs without applying an unreasonable amount of stress on the clamp.

While a preferred embodiment of the invention has been shown and described, changes can be made without departing from the principles and spirit of the invention, the scope of which is defined in the following claims.

What is claimed is:

1. A clamp device for engaging a conductive stud attached to a conductive support in order to mount a long component on the support conductively, wherein the clamp device comprises a clamp made of an electrically conductive hard plastic material having a base for holding the long component, a cover made of a hard plastic material connected to the clamp so as to enclose the long component on the base, and a stud fastener made of a hard plastic material, separate from the cover and the clamp, and engageable with the stud for mounting both the clamp and the cover on the stud and for initiating an electrical connection of the clamp to the stud to electrically connect the long member held inside the clamp to the stud and the support.

2. The clamp device described in claim 1, wherein the clamp has a stud receiver with a hole to receive a stud, and wherein conductive plates on the stud receiver extend inside the stud fastener to establish electrical contact with a stud when the stud fastener receives a stud.

3. The clamp device described in claim 2, wherein the cover is connected to the base by a hinge so as to be opened to arrange a long component on the base and closed to enclose and hold the long component on the base, and has a fastener connector with a hole into which the stud fastener is inserted.

4. The clamp device described in claim 3, wherein the stud fastener comprises a stud-receiving tube with a head on one end of the tube, wherein elastic pawls are formed inside the tube to engage threads or circumferential grooves on the side of the stud, wherein the tube is inserted into the fastener connector, wherein pushing on the head of the tube to insert the stud causes the elastic pawls to engage threads or grooves on the side of the stud and causes the clamp and the cover to be mounted on the stud, and wherein the tube causes the conductive plates to apply pressure to the side of the stud.

5. The clamp device described in claim 4, wherein the fastener connector of the cover and an end of the tube opposite to the head of the stud fastener have engagement means that are connected before the stud fastener is pushed onto the stud.

6. A clamp device for engaging a conductive stud attached to a conductive support in order to mount a long component on the support conductively, comprising:
a conductive clamp with a base constructed for engagement with the support and having at least one recess for receiving a long component;
a cover having a first portion constructed for attachment to the base and a second portion hinged to the first portion for movement between a first position away from the base and a second position adjacent to the base, wherein the second portion has at least one recess which complements a corresponding recess of the base to enclose a long component, and wherein the cover and the base have cooperable elements for latching the cover in the second position;
a conductive stud receiver connected to the base and having a hole for receiving a stud attached to the support; and
a stud fastener separate from the clamp and the cover and constructed for insertion through a hole in the first portion of the cover in alignment with the hole in the stud receiver,
wherein the stud fastener has a tube for receiving a stud therein, the tube has a pawl for engaging the received stud to secure the tube to the stud, and wherein the stud receiver has an electrical contact disposed for insertion in the stud fastener between the tube and stud, whereby the conductive clamp is electrically connected to the stud and the support.

7. The clamp device described in claim 6, wherein the electrical contact includes a pair of plates extending from the hole in the stud receiver toward the hole in the first portion of the cover, and wherein the tube of the stud fastener has an end facing the plates with an internal tapered configuration to urge the plates toward a side of the stud as the stud fastener is moved over the stud.

8. The clamp device described in claim 7, wherein the first portion of the cover includes a stud fastener connector, and the stud fastener connector and the stud fastener have cooperable elements for holding said end of the tube at a position adjacent to the stud fastener connector prior to a stud being received in the tube.

9. A clamp device for engaging a conductive stud attached to a conductive support in order to mount a long component on the support conductively, comprising:
a first section including a conductive base with at least one recess for receiving a long component;
a second section extending from an end of the base and having a pair of substantially parallel walls, one of which is a stud receiver conductively connected to the base with a first hole for receiving a stud, and the other of which is a stud fastener connector with a second hole aligned with the first hole, wherein an electrical contact extends from the first hole toward the second hole; and
a separate stud fastener having a tube insertable in the second hole for receiving the stud and the electrical contact upon movement of the stud fastener toward the first hole, with the electrical contact disposed between a side of the stud and an inner wall of the tube.

10. The clamp device of claim 9, wherein the electrical contact includes a pair of plates at opposite sides of the first hole, and wherein the tube of the stud fastener is constructed to urge the plates against the side of the stud when the stud is inserted in the stud fastener.

11. The clamp device of claim 9, wherein the tube of the stud fastener has an internal pawl for engaging the stud to secure the stud fastener to the stud.

12. The clamp device of claim 9, wherein the stud fastener and the stud fastener connector have cooperable elements for preliminarily maintaining the stud fastener at a position spaced from the stud receiver.
